(19) United States
(12) Patent Application Publication
(10) Pub. No.: US 2007/0167188 A1
(43) Pub. Date: Jul. 19, 2007

(54) A SYSTEM AND A DEVICE FOR MOBILE RADIO COMMUNICATION

(76) Inventor: Kjell LINDEN, Hagersten (SE)

Correspondence Address: YOUNG & THOMPSON, 745 SOUTH 23RD STREET, 2ND FLOOR, ARLINGTON, VA, 22202, US

(21) Appl. No.: 10/555,760

(22) PCT Filed: May 13, 2004
(86) PCT No.: PCT/SE04/00736

§ 371 Date: Dec. 15, 2006

(30) Foreign Application Priority Data
May 14, 2003 (SE) 0301404-0

(51) Int. Cl. H04M 1/00

(52) U.S. Cl. 455/552.1; 455/412.1

(57) ABSTRACT

The present invention relates to a telephone service device and a system comprising a telephone service device for providing telephone services to a television apparatus (10). The technical field of this invention will be a convenient solution how to use an ordinary TV apparatus, normally in the home environment, as a terminal for telephone services, e.g. watching MMS (Multimedia Message Service), SMS (Short-Message Service) and Streamed mobile media, and telephone video conference. This platform will also be possible to use as the terminal for a loudspeaking multimedia communication platform. The arrangement will also make it easy to respond and keep on a dialog with others in the “mobile community”. The telephone service device comprises a telephone service main unit (20) for connection to the television apparatus (10), and a separate operator unit (22), which is movable in relation to the main unit (20).

### TECHNICAL FIELD

The present invention relates to a system and a device for mobile radio communication. In more detail, the present invention relates to a telephone service device and a system comprising a telephone service device for providing telephone services to a television apparatus.

The technical field of this invention will be a convenient solution how to use an ordinary TV apparatus, normally in the home environment, as a terminal for telephone services, e.g. watching MMS (Multimedia Message Service), SMS (Short-Message Service) and Streamed mobile media. This platform will also be possible to use as the terminal for a loud speaking multimedia communication platform. The arrangement will also make it easy to respond and keep on a dialog with others in the “mobile community”.

The solution will be optimised for keeping on voice and message conversation between the home, the TV as terminal, and someone out travelling with a mobile phone including SMS and or MMS and/or streamed mobile media possibility.

### BACKGROUND OF THE INVENTION

This solution is optimised to be an accessory to the TV apparatus in the home The solution will support an “always on” solution. The idea is to have the solution optimised for all the way, from people on the move, to the “people at home in the sofa”. The idea is also to use it as a loudspeaker telephone. The device enables to create text, graphics and video content and send it over the mobile network, to other person phones, PC's or TV apparatuses.

Today the idea is to send the MMS (Multimedia Messaging Service) messages, e.g. photos, to other mobile phones or as an attachment to a mail in order to display the MMS message on a PC. The present invention allows MMS, SMS and Streamed multimedia to be displayed on the TV. More and more mobile phones will include a digital camera or the camera will be optional as an accessory. This will open up the possibility to send MMS to someone, according to the MMS standard, and in the future also streamed video. The invention comply fully with existing global standards 3G, GSM, Mobile Phones, MMS/SMS, Bluetooth, USB, SCART etc. The invention will fit in and be seen as a natural evolution. The solution will be optimised for keeping on a message conversation between the home, the TV as terminal, and someone out travelling with a mobile phone including SMS and/or MMS and/or streamed video possibility.

The published patent application WO-0160089 presents a method and an apparatus for enabling a user of a mobile terminal to access data services using a display device having a large screen relative to that of the mobile terminal. The mobile terminal is connected to an interface module configured to receive data through the mobile terminal. The interface module converts the data into a format that can be displayed on a conventional television screen. An advantage of using a conventional television screen is that greater textual and graphical information can be displayed to the user, as compared to the display of the mobile terminal. The interface module may also receive input data from a user and transmit the input data to a service provider through the mobile terminal. The interface module connects to a data bus of the mobile terminal so that data may be received or transmitted through the mobile terminal. The interface module includes a user agent, e.g. a web browser, for presenting the data on a television screen. A system for facilitating processing of data to and from the data bus of the mobile terminal includes a mobile terminal comprising a data bus for receiving and transmitting data to a wireless communication network. The system further includes an output device for presenting at least one of audio, video, and textual information to a user, and an interface module connected to the data bus of the mobile terminal. The interface module includes: (1) a protocol stack for processing data to and from the data bus of the mobile terminal in accordance with at least one communication protocol; (2) a user agent for interpreting data to and from the protocol stack; (3) a signal generator for converting the interpreted data from the user agent into signals for the output device.

The earlier published patent application EP-1059809 discloses a coupling device for attaching a mobile station to a television device. The television device has a first input to receive an external information signal in a certain first format. The coupling device comprises short range radio frequency communication means for receiving information from an external device, a mobile station; means for converting the received information into said information signal in a first format; and a first output for supplying said information signal in the first format to the first input of said television device. Further, a system is disclosed comprising a mobile terminal, the coupling device and a television device. The mobile terminal has means for short range radio frequency for sending information to the coupling device. Moreover, a method is disclosed for coupling a mobile terminal to a television device, which television device has a first input to receive external information signal. A coupling device is attached to the first input in order to receive information sent on a short range radio frequency from the mobile terminal. The received information is converted to a first format suitable for the television device and the information in the first format is supplied to the first input of the television device.

The earlier published patent application EPO 0 999678 A2 discloses a systems and methods for integrating video, audio and mobile radiophone technology. The solution is based on a cradle for providing video and audio signals to television or other display devise such that a user may view data and make transactions. The cradle receives external data via either a wireless telephone network or a land-line based telephone network from a computer. The cradle then combines this external data with data stored in an internal memory or a removable memory device so as to form a composite video image that the user understands.

Said prior art has a number of drawbacks. One such drawback is the additional complexity and cost burden of interfacing a separate mobile radio terminal (cellular telephone) for connecting the cradle to the cellular network, as each specific mobile radio terminal model requires a specific adapter. This prior art will also have a cost burden in the ability to use a lot of different access technologies, inbuilt loudspeaker, volume knob, keyboard, controls etc.

The wireless data link between the mobile radio terminal and the adapter uses Low Power Radio Frequency transceivers for communicating data, audio and video information, wideband information, over said extra air interface. This extra air interface requires extra antennas and transceivers, decreases the transmission data rate, decreases signal strength and introduces noise into the signal traffic.

### BRIEF DESCRIPTION OF THE INVENTION

All these three earlier known adapters utilize a separate mobile terminal for relaying data from the mobile network to the television receiver.

One problem by using a separate mobile terminal as a relay apparatus is that wireless data link between the adapter and the separate mobile terminal is bandwidth and data rate limited. This is a bottleneck in the communication system. A user has to buy a new upgraded mobile terminal to increase bandwidth and data rate of said data link. Of several reasons, a user will find such a solution very expensive. For video conference over the mobile network, a very powerful processor is needed. If high video quality is required, the processor in a mobile terminal has quite limited performance.

Another problem by using a separate mobile terminal is that the keyboard is small and limited. Only a very small number of the mobile terminals today provide a full alphanumeric keyboard. The manufacturers of mobile terminals develop smaller and smaller mobile terminals including more and more functions and services. New function keys have to be provided on a smaller front area. The keys have to be smaller and many people, especially old or handicapped people, find that very inconvenient. Said people cannot use a mobile terminal or have no use of a mobile terminal as they don't or seldom leave their apartment. They will therefore not buy a mobile terminal.

Yet another general problem of using a separate mobile radio terminal is that it is not always available, due to the mobile and personal nature of a separate radio terminal. I.e. the adapter/cradle/main unit connected to the TV set is not necessarily “always on” (connected). Due to the same reason, it does not provide the adapter/cradle/main unit with a fix and unique identifier (a telephone number).

The object of the present invention is to overcome the above mentioned problems.

Another object of the present invention is to provide a customer friendly and powerful video telephone conference equipment.

The solution is based on a remotely controlled device for MMS/SMS/Streamed video to TV. The device according to the invention is a telephone service device and a telephone service system comprising the telephone service device, which is constituted of a telephone service main unit for detachable connection to the television apparatus, and a separate operator unit which is movable in relation to the main unit.

In more detail, the present invention relates to a telephone service device for providing telephone services to a television apparatus with a screen/display, the device consisting of two units only:
a telephone service main unit for connection to the television apparatus, and a separate operator unit which is movable in relation to the main unit; wherein
the telephone service main unit has a housing, which encloses a television/cellular radio format converter module for interacting with the television circuitry of the television apparatus, a cellular radio module for cellular radio communication, operator unit I/O interface module for interacting with the operator unit, and a control processor for controlling the different modules, and signals from the converter module to a cellular network and signals from the cellular network to the converter module will only pass one external interface, the air interface; and
the operator unit comprises a main unit I/O interface module for interacting with the main unit, a telephone service indicating means, a keyboard and an operator unit controller.

Further, the present invention relates to a telephone service system for providing telephone services to a television apparatus having television circuitry for receiving and processing television and/or video and audio signals, and a screen for displaying the television and/or video signals;
a telephone service device, which consists of two units only, a telephone service main unit for connection to the television apparatus, and a separate operator unit which is movable in relation to the main unit, wherein
the telephone service main unit has a housing, which encloses a television/cellular radio format converter module for interacting with the television circuitry, a cellular radio module for cellular radio communication, operator unit I/O interface module for interacting with the operator unit, and a control processor for controlling the different modules, and signals from the converter module to a cellular network and signals from the cellular network to the converter module will only pass one external interface, the air interface; and
the operator unit comprises a main unit I/O interface module for interacting with the main unit, a telephone service indicating means, a keyboard and an operator unit controller.

In one embodiment of the invented system and device the operator unit also comprises a microphone unit for transducing an operator's voice to audio signals.

One advantage over the prior art is that the present invention is easier to handle for a handicapped and/or old person.

Further, one advantage is that a main unit is optimised for the television media only. In prior art, the known adapters is optimised for the use of a separate mobile terminal. The invented device is more powerful than a mobile terminal and, the device has therefore stronger processing power, better and faster processors and larger memory, providing a suitable platform for advanced “mobile services”, e.g. message editing, picture editing etc.

Another advantage is that the present invention does not involve a separate mobile terminal for cellular radio communication. The invention incorporates less elements and eliminates one external air interface.

Yet another advantage is that the invention does not involve a bandwidth and data rate limiting interface.

As the present invention includes a dedicated integrated cellular radio module, the external, and proprietary, interface between the adapter/cradles/cradles and a the mobile terminal is eliminated.

Also, it provides the main unit, and accordingly the connected TV set, with an “always on” connection, as well as a unique identity (telephone number), thereby also enabling standard methods of charging/billing the consumption of mobile telephony services, specifically using the TV as a terminal.

This is achieved by using a SIM card for accessing the cellular radio network, the SIM card being connected the cellular radio module of the main unit.

Other advantages, objects and features of the present invention will become apparent from the following detailed description in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein. dr

### BRIEF DESCRIPTION OF THE DRAWINGS

Preferred embodiments of the present invention will in the following be described in more detail with reference to the drawings, in which:

FIG. 1 is a schematic block diagram illustrating a telephone service system according the present invention;

FIG. 2 is a schematic block diagram of the main unit of the telephone service device according to the invention;

FIG. 3 is a schematic block diagram of the cellular radio module in the main unit of the telephone service device according to the invention;

FIG. 4 is a schematic block diagram of the operator unit of the telephone service device according to the invention.

### DETAILED DESCRIPTION OF THE INVENTION

It should be appreciated that the present invention is equally applicable to Digital Advance Mobile Phone Service (D-AMPS), TDMA, Code Division Multiple Access (CDMA), Global System for Mobile Communication (GSM), Pacific Digital Cellular (PDC), Wide CDMA (W-CDMA), General Packet Radio Standard (GPRS), CDMA 2000, Enhanced Data for GSM Evolution (EDGE), 3G, UMTS/IMT 2000 and similar standards and techniques.

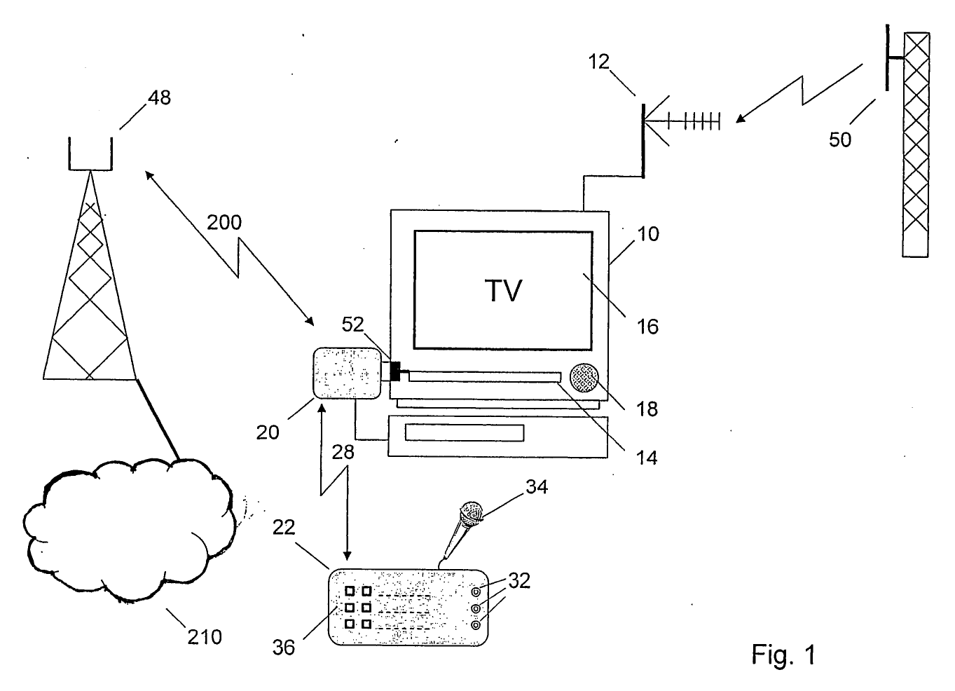

FIG. 1 is a schematic block diagram illustrating a telephone service system according to a preferred embodiment of the invention for providing telephone services to a television apparatus with a screen/display. Said system comprises a television apparatus 10 comprising a television circuitry 14 for receiving and processing television and/or video and audio signals, and a display or screen 16 for displaying the television and/or video signals, a telephone service device that comprises a telephone service main unit 20 for detachable connection to the television apparatus, and a separate operator unit 22, which is movable in relation to the main unit, wherein the telephone service main unit 20 comprises a television/cellular radio format converter module 24 for interacting with the television circuitry 14, a cellular radio module 26 for cellular radio communication, operator unit I/O interface module 28a for interacting with the operator unit 22, and a control processor 30 for controlling the different modules, and the operator unit 22, which comprises a main unit I/O interface module 28b for interacting with the main unit 20, a telephone service indicating means 32, a microphone unit 34 for transducing an operator's voice to audio signals, a keyboard 36 and an operator unit controller 60.

The different details of the system will in the following be described in more detail.

The telephony service device according to the present invention supports telephone services as all mobile radio services and applications according to any of the above identified standards. Examples of what is meant with telephone service are MMS, SMS, Mobile streamed Media, loudspeaker phone, e-mail, Internet, WAP, video telephony conference. A number of different external equipment, such as digital video camera, digital camera, printer, additional data storage, computer or PC, etc, are connectable to the the device for supporting the services.

The television apparatus 10 comprises a television circuitry 14 for receiving and processing television and/or video and audio signals, a display or screen 16 for displaying the television and/or video signals and at least one loudspeaker 18. The television circuitry 14 is able to receive and process television signals via an antenna connector from a television broadcasting network and antenna 12 or cable-TV network. The television circuitry 14 is able to receive and process television signals via other input ports, e.g. SCART (Syndicat des Constructeurs d'Appareils Radio Récepteurs et Téléviseurs) port. A television apparatus, or TV apparatus, in this context denotes an apparatus capable of receiving a TV-signal, such as a television receiver, HDTV (High Definition TeleVision) receiver, a TV-projector (an apparatus to project TV-image on a screen) and a video recorder.

The different details of the telephone service device 20, 22 will in the following be described in more detail.

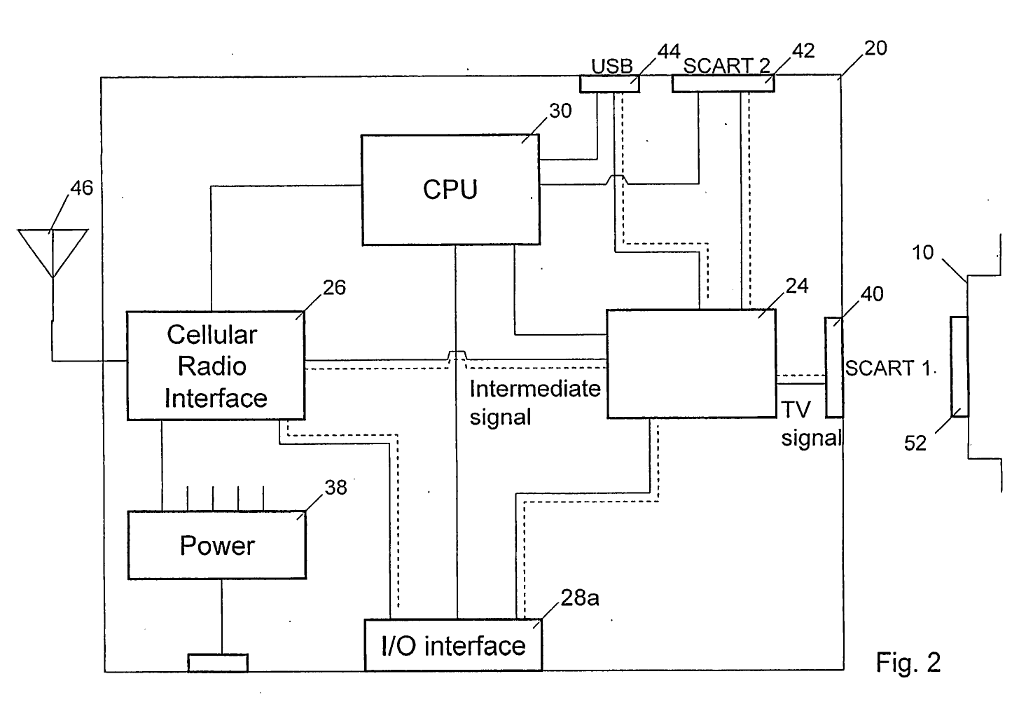

FIG. 2 is a schematic block diagram of the main unit of the telephone service device according to the invention.

The main unit 20 according the present invention is adapted to be connected to an input port 52 of the TV-apparatus 10. The unit 20 has a housing, which encloses a television/cellular radio format converter module 24 for interacting with a television circuitry, a cellular radio module 26 for cellular radio communication, operator unit I/O module 28a for interacting with a operator unit, and a control processor 30 for controlling the different modules and controllers. The control processor 30 is connected to the controllers via data buses. For video conference over the mobile network, a very powerful processor is needed. If high video quality is required, a processor in a mobile terminal has quite limited performance. Further, the main unit may comprise a number of different ports, such as SCART-ports 40; 42, USB-port 44 etc. Moreover, a power module 38 is provided for supplying the circuitry of the modules in the main unit with electric power, preferably the fixed electrical distribution system. One option could be to power the main unit via the SCART connector.

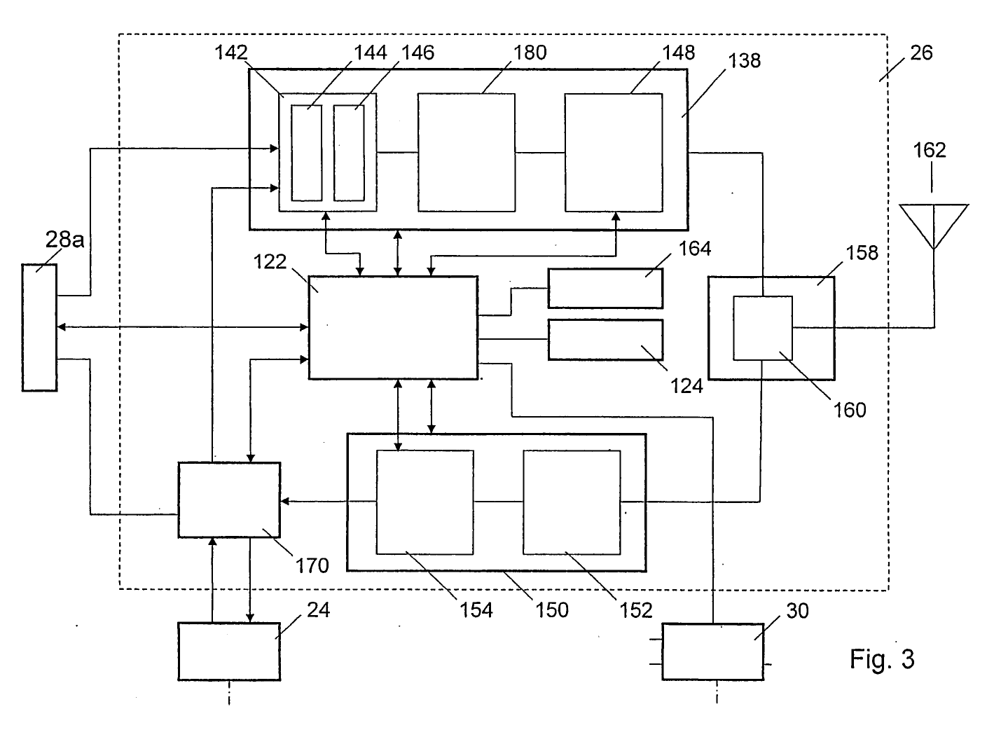

The television/cellular radio format converter module 24 is connected to a port 40 that is intended for a corresponding port 52 at the television apparatus 10. Preferably the ports are SCART-connectors and the fast blanking-function characteristic thereto. The function enables the telephone service device, when receiving information from the cellular radio module 26 or by manually instructions from the operator unit, to automatically force the TV apparatus to present the information supplied by the cellular radio module 26. The television/cellular radio format converter module 24 for conversion of the television video signals and the output data signal, the intermediate image signal, from the the cellular radio module 26 may be implemented in different ways, known by the skilled person. One such known implementation is described in more details in EP 1 059 809, FIG. 3, and page 4, column 5, line 25—page 5, column 7, line 5.

In one embodiment of the main unit according to the present invention, the cellular radio module comprises a protocol converter for conversion of any one of protocol used for MMS, SMS, WAP Internet or streaming multimedia and an intermediate image signal, which is transmitted between the protocol converter and the television/cellular radio format converter module (24), which comprises a format converter for conversion between the intermediate image signal and appropriate television or video and audio signals for presentation on the screen of the television apparatus. These format converters comprises microprocessors and protocol/format software.

Turning now to FIG. 3 and the cellular radio module 26, which includes a controller 122, a transmitter 138, a receiver 150, and an antenna assembly 158.

Transmitter 138 includes a digital signal processor 142, and a phase modulator and RF amplifier 148. The digital signal is passed to the digital signal processor (DSP) 142, which contains a speech coder 144 and channel coder 146. Speech coder 144 compresses the digital signal and the channel coder 146 inserts error detection, error correction and signalling information. DSP 142 may include, or may work in conjunction with, a DTMF tone generator (not shown). The compressed and encoded signal from the digital signal processor 142 is passed to the phase modulator and RF amplifier 148, which are shown as a combined unit in FIG. 3. The modulator converts the signal to a form that is suitable for transmission on an RF carrier. RF amplifier 148 then boosts the output of the modulator for transmission via the antenna assembly 158. Different mobile standards need different additional radio circuits, e.g. burst generation etc, which is indicated in the figure with the block 180.

Receiver 150 includes a receiver/amplifier 152 and a digital signal processor 154. Signals received by the antenna assembly 158 are passed to the receiver/amplifier 152, which shifts the frequency spectrum, and boosts the low-level RF signal to a level appropriate for input to the digital signal processor 154.

Digital signal processor 154 typically includes an equalizer to compensate for phase and amplitude distortions in the channel corrupted signal, a demodulator for extracting bit sequences from the received signal, and a detector for determining transmitted bits based an the extracted sequences. A channel decoder detects and corrects channel errors in the received signal. The channel decoder also includes logic for separating control and signaling data from speech data. Control and signaling data are passed to the controller 122. Speech data is processed by a speech decoder and passed to the TV-apparatus, in which a digital to analog converter converts the speech data into an analog signal that is applied to the speaker to generate acoustic signals that can be heard by the user. Digital signal processor 154, may include, or may work in conjunction with, a DTMF tone detector (not shown).

Antenna assembly 158 is connected to the RF amplifier of the transmitter 138 and to the receiver amplifier 152 of the receiver 150. Antenna assembly 158 typically includes a duplexer 160 and an antenna 162. Duplexer 160 permits full duplex communications over the antenna 162 including the possibility to connect the antenna via an external RF cable in order to remove it from the TV set (interference) and improving RF reception.

Controller 122 coordinates the operation of the transmitter 138 and the receiver 150, and may for instance take the form of a typical microprocessor. This microprocessor may be a dedicated or shared microprocessor and may be a single processor or multiple parallel processors as needed or desired. This coordination includes power control, channel selection, timing, as well as a host of other functions known in the art. Controller 122 inserts signaling messages into the transmitted signals and extracts signaling messages from the received signals. Controller 122 responds to any base station commands contained in the signaling messages, and implements those commands. When the operator/user enters commands via the keyboard 36, the commands are transferred to the controller 122 for action. Memory 124 stores and supplies information at the direction of the controller 122 and preferably includes both volatile and non-volatile portions. Memory 124 will be large in order to store messages and streaming Multimedia. The main unit 20 for use in a GSM system may comprise its own SIM card and a SIM-card holder 164, the SIM-card is necessary for access to the radio network (e.g. GSM and/or 3G).

As mentioned erlier in the description, in one embodiment of the main unit according to the present invention, the cellular radio module (26) comprises a protocol converter (170) for conversion of any one of protocol used for MMS, SMS, WAP Internet or streaming multimedia and an intermediate image signal, which is transmitted between the protocol converter and the television/cellular radio format converter module (24), which comprises a format converter for conversion between the intermediate image signal and appropriate television or video and audio signals for presentation on the screen of the television apparatus. These format converters comprises microprocessors and protocol/format software.

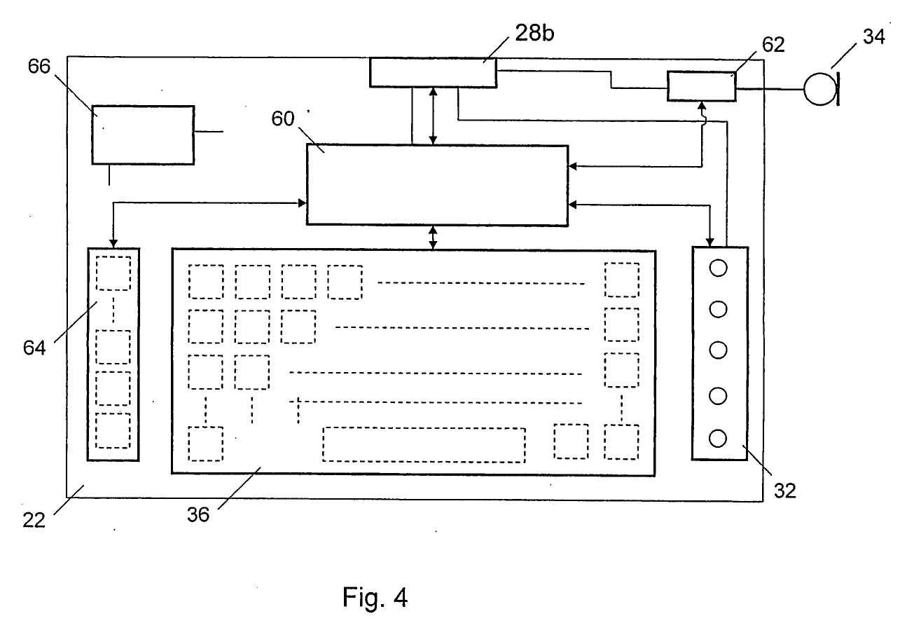

Now turning to FIG. 4 and the operator unit 22 according to the present invention. The operator unit 22 includes a main unit I/O interface module 28b for interacting with the main unit 20, telephone service indicating means 32, a microphone unit 34 for transducing an operator's voice to audio signals, a keyboard/keypad 36 and an operator unit controller 60. The display 16 of the TV-apparatus 10 (see FIG. 1) allows the operator to see dialed digits, call status, written messages and other telephone service information, e.g. SMS, WAP and MMS. Keyboard 36 allows the operator to write alphanumerical letters, dial numbers, enter commands, and select options. Operator unit controller 60 interfaces the keyboard 36 with the control processor 30 of the main unit 20. Microphone 34 receives acoustic signals from the user and converts the acoustic signals to an analog electrical signal. Analog to digital converter 62 changes the analog electrical signal from the microphone 34 into a digital signal. The telephone service indicating means 32 is able to call the operator's attentation by light or sound signals, when a call, a short message, a MMS or streamed mobile media is received by the cellular radio module 26. The operator unit 22 also comprises control keys 64 for communication control. The operator units also need some kind of power source 66, preferably a rechargeable battery source.

The wireless communication between the main unit and operator unit is solved by use of a transceivers in the I/O interface modules 28a and 28b. The transceivers may support any wireless communication operating according to Bluetooth, WLAN or via an optical link.

The analog electrical signal from the microphone 34 is analog-to-digital-converted in the converter 62, and the digital voice information signal is supplied to the I/O interface module 28b of the operator unit 22 that transmits the digital voice information signal to the I/O interface module 28a of the main unit 20. The I/O interface module 28a is connected to the cellular radio module 26 and the voice information signal is supplied via the internal circuits of the module 26 to the transmitter 138 and the antenna 46 for transmission via the air interface 200 to a relaying station of a cellular radio network 210, e.g. a base station 48 (GSM).

It is also possible to expand the systems and the device functionalities gradually by adding software downloads including new functionality (Loud speaking Phone functionality, wireless phone, Camera input, Printer functionality, PC interface etc)

The invented device is, when it is not engaged in communication, passively connecting whatever is connected to the SCART input, VHS or DVD to the scart to the TV apparatus. When the device goes active, such as at reception or creation of SMS or MMS or when used in telephone conversation, a switch disconnects the incoming scart and connect the cellular radio module with television/cellular radio format converter.

Whatever SMS or MMS messages received or created in the mobile network transceiver are converted into teletext and inserted in the video coder/decoder. External equipment, such as MMS phones, digital cameras, video cameras or printers or even adapters to the home data network may be connected to the Interface to Accessories, which could be implemented as a USB, Bluetooth or WLAN.

Another embodiment of the present invention is a plug-in card design of the main unit. In the first described embodiment, the main unit has a housing of its own and the main unit is attached to an appropriate connector directed through housing of the TV apparatus, for instance a SCART-connector. However, if the main unit is designed as a plug-in card, the unit may be inserted, or fixed attached by soldering to the rest of the television circuitry, inside the housing of the television apparatus. The material of the main unit housing may be resin, plastic or metal or an alloy, e.g. for RF shielding purposes.

The principles of operation will now be discussed in more detail.

The first example relates to the receipt of a SM (short Message).

The device is started in passive mode. The SM is received in the cellular radio module 26. Alphanumeric information is extracted from received message by the radio module controller 122 and temporary stored in the memory 124. The radio module controller 122 generates and transmits to the operator unit controller 60 of the operator unit a signal that a message has been received. The controller 60 will activate the telephone service indicating means 32 to indicate by sound and/or light signalling the reception of the message. The signalling is repeated at predetermined time intervals until the signal is manually acknowledged at the operator unit by the user/operator, who initiates the presentation of the message by pressing the appropriate control key 64. A “show-message”-signal is generated by the operator unit controller 60 and transmitted to the control processor 30, which order the radio module controller 122 to access the SM from the memory 124 and transmit the message to the converter module 24. The control processor 30 informs the converter module 24 that a SM is to be handled and converted to the television signal format. Any ongoing transport of video/audio signals between the incoming SCART interface from external equipment is disrupted by the blanking function, and the converter module 24 is made ready to present the text message. The alphanumeric information is converted and inserted over the SCART-interface 40 to the television circuitry 14 for presentation on the display/screen 16 of the TV-apparatus 10. The operator unit 22 communicates with the control processor 30 during the presentation phase, for actions such as scrolling text up or down or sending the information to the external USB interface 44 of the main unit 20. Termination of the presentation phase is initiated by pressing a key on the keyboard 36. The telephone service device shifts over to passive mode, and enables information to pass between the incoming scart interface of external equipment, and the TV.

The second example relates to the sending of a short message, SM. The telephone service device starts in passive mode. The user/operator sets the control processor 30 of the main unit 20 in edit-mode by using one of the control keys 64 on the operator unit 22. The operator then creates a message by using the keyboard. Any ongoing transport of video/audio signals between the incoming scart interface from external equipment is disrupted by the blanking function, and the converter module 24 is made ready to present the text message. The message is typed on the keyboard. The keyboard communicates via the operator unit controller 60 with the converter module 24 during the presentation phase, for actions such as scrolling text up or down or sending the information to the external USB interface of the apparatus. When the message typing is completed, the operator orders the operator unit controller 60 to finish the edit mode and send the message to the cellular radio module 26 via the I/O interface 28. Termination of the edit mode is initiated by pressing a predetermined key of the control keys 64 on the operator unit. Alphanumeric information is extracted from the typed message. Sending the SM is initiated by pressing another one of the control keys 64 of the operator unit. The sending of the SM is performed and handled in the known manner of mobile terminals by the cellular mobile module 26, e.g. dial number etc. When the message has been transmitted, the telephone service device shifts over to passive mode, and enables information to pass between the incoming scart interface of peripheral equipment, and the TV.

The third example relates to the receiving of MMS, Graphics Video and Audio.

The telephone service device starts in passive mode. The MMS is received in the cellular radio module 26. Alphanumeric heading information is extracted from received graphical audio and video information MMS by the radio module controller 122 and the Graphical audio and video information MMS is temporary stored in the memory 124. The radio module controller 122 generates and transmits to the operator unit controller 60 of the operator unit a signal that a graphical audio and video information MMS has been received. The controller 60 will activate the telephone service indicating means 32 to indicate by sound and/or light signaling the reception of the MMS. The signalling is repeated at predetermined time intervals until the signal is manually acknowledged at the operator unit by the user/operator, who initiates the presentation of the MMS by pressing the appropriate control key 64. A “show-MMS”-signal is generated by the operator unit controller 60 and transmitted to the control processor 30, which order the radio module controller 122 to access the MMS from the memory 124 and transmit the MMS to the converter module 24. The control processor 30 informs the converter module 24 that a MMS is to be handled and converted to the television signal format. Any ongoing transport of video/audio signals between the incoming scart interface from external equipment is disrupted by the blanking function, and the converter module 24 is made ready to present the MMS. The MMS is converted and inserted over the SCART-interface 40 to the television circuitry 14 for presentation on the display/screen 16 of the TV-apparatus 10. Video and graphics are presented on the TV screen, audio is presented in the TV loudspeakers. The operator unit 22 communicates with the control processor 30 during the presentation phase, for actions such as scrolling text up or down or sending the information to the external USB interface 44 of the main unit 20. Termination of the presentation phase is initiated by pressing a control key 64 on the operator unit 22. The telephone service device shifts over to passive mode, and enables information to pass between the incoming scart interface of external equipment, and the TV.

The fourth example relates to the receiving of incoming Telephone and video conference calls.

The device is started in passive mode. A call is received in the cellular radio module 26. Alphanumeric information is extracted from received call by the radio module controller 122 and temporary stored in the memory 124. The radio module controller 122 generates and transmits to the operator unit controller 60 of the operator unit 20 a signal that a call has been received. The controller 60 will activate the telephone service indicating means 32 to indicate by sound and/or light signalling the reception of the call. The signalling is repeated at predetermined time intervals until the signal is manually acknowledged at the operator unit by the user/operator. If the call is not accepted the signalling indicated is timed out and the telephone service device return to passive mode. The user/operator initiates the acceptance of the call by pressing the appropriate control key 64. Any ongoing transport of video/audio signals between the incoming scart interface from external video equipment is disrupted, and the converter module 24 is made ready to present any alphanumeric information in combination with the telephone call such as calling number. The alphanumeric information is converted and inserted via the converter module 24 and the alphanumeric information is transmitted to the TV apparatus and displayed on the display. An image of the caller may be associated by the calling number and presented on the display. The image is accessed from an internal store of the device. Initiation of the presentation of the Graphics, video and audio parts of the MMS or telephony and video conference calls is initiated from the operator unit 22. The microphone 34 in the operator unit is activated, and the audio signal thus created is sent over the main unit to the TV-apparatus and to the cellular radio network. The audio from the microphone is signal processed and filtered by the operator unit controller so no acoustic feedback distortion occur. The operator communicates via the operator unit 22 and the keyboard 36 with the converter module 24 during the presentation phase, for actions such as key-board control of the telephone functionality, scrolling text up or down or sending the information to the external USB interface of the telephone service device.

For a video conference call, a digital video camera can be connected to the external USB interface of the main unit to create an outgoing picture. In case a user owned camera is used in the video conference call it is possible to create a Picture in picture presentation on the TV screen from this camera. Instead of a USB interface, the main unit may be provided with a port for wireless communication using Bluetooth or WLAN techniques.

Graphical, Video and audio information is converted by the converter module to the format adapted to the TV and transported over the SCART interface to the TV. Video and graphics are presented on the TV screen, audio from the incoming call is presented in the TV loudspeakers. Termination of the presentation phase is initiated by pressing a control key 64 on the operator unit.

The telephone service device shifts over to passive mode, and enables information to pass between the incoming SCART interface of peripheral equipment, and the TV.

The fifth example relates to the making of outgoing Telephone and video conference calls.

The telephone service device starts in passive mode. The user/operator sets the control processor 30 of the main unit 20 in edit-mode by using one of the control keys 64 on the operator unit 22. The operator initiates the telephone call/video conference from the operator unit 22 by keying an outgoing phone number, subscriber number or B-number. Any ongoing transport of video/audio signals between the incoming SCART interface from external equipment is disrupted by the blanking function, and the converter module 24 is made ready to present the text message. The keyboard communicates via the operator unit controller 60 with the converter module during the presentation phase, for actions such as scrolling text up or down or sending the information to the external USB interface of the apparatus. Termination of the edit mode is initiated by pressing a control key 64 on the operator unit. By pressing a call key of the control keys 64 on the operator unit 22, the telephone number is sent and a call is initiated. When the receiver of the call answers the call, the completion of the call setup is detected in the cellular radio module 26 and a conference-setup-signal is generated by the controller 122 and transmitted to the control processor 30. The telephone service device is set into conference mode and the telephone and video conference is initiated from the control processor 30. The microphone 34 in the operator unit is activated, and the audio signal thus created is sent to the cellular radio module of the main unit. The audio from the microphone is signal processed and filtered by the operator unit controller so no acoustic feedback distortion occur. The operator communicates via the operator unit 22 and the keyboard 36 with the converter module 24 during the conference phase, for actions such as key-board control of the telephone functionality, scrolling text up or down or sending the information to the external SUB interface of the apparatus.

If the call is not successful the call setup is timed out, a text of failure to set up is presented on the TV and the apparatus return to passive mode after a short delay period

For a video conference call, a digital video camera can be connected to the external USB interface of the main unit to create an outgoing picture.

Instead of a USB interface, as in above discussed embodiments, the main unit may be provided with a port for wireless communication using Bluetooth, WLAN or optical techniques.

In case a user owned camera is used in the video conference call it is possible to create a Picture in picture presentation on the TV screen from this camera.

Termination of the presentation phase is initiated by pressing a control key 64 on the operator unit.

The telephone service device shifts over to passive mode, and enables information to pass between the incoming SCART interface of external video equipment, and the TV.

A person skilled in the art realize that the present invention solves the above identified problems and achieves the above mentioned objectives.

In the described embodiments and the following claims, the term module has been used in a generic and descriptive sense. However, the invention is not limited to module designs of the invention. Inside the described units, the circuits of the different modules may be divided into sub-modules or sub-blocks.

In the drawings and specification, there have been disclosed typical preferred embodiments of the invention and, although specific terms are employed, they are used in a generic and descriptive sense only and not for purposes of limitation, the scope of the invention being set forth in the following claims.

1. Telephone service system for providing telephone services to a television apparatus (10) with a screen/display (16), the system comprises:
a television apparatus (10) comprising a television circuitry (14) for receiving and processing television and/or video and audio signals, and a screen (16) for displaying the television and/or video signals
a telephone service device, which consists of two units (20,22) only, a telephone service main unit (20) for connection to the television apparatus (10), and a separate operator unit (22) which is movable in relation to the main unit (20), characterized in that:
the telephone service main unit (20) has a housing, which encloses a television/cellular radio format converter module (24) for interacting with the television circuitry (14), a cellular radio module (26) for cellular radio communication, operator unit I/O interface module (28a) for interacting with the operator unit (22), and a control processor (30) for controlling the different modules, and signals from the converter module (24) to a cellular network (48, 210) and signals from a cellular network (48, 210) to the converter module (24) will only pass one external interface, the air interface (200); and
the operator unit (22) comprises a main unit I/O interface module (28b) for interacting with the main unit (20), a telephone service indicating means (32), a keyboard (36) and an operator unit controller (60).

2. Telephone service system according to claim 1, characterised in that the separate operator unit (22) comprises a microphone unit (34) for transducing an operator's voice to audio signals.

3. Telephone service system according to claim 1, characterised in that the main unit (20) is provided with a first SCART-interface (40) for connection to a SCART-interface (52) of the television apparatus (10).

4. Telephone service system according to claim 1, characterised in that the main unit is provided with a SCART-interface for connection to external video equipment.

5. Telephone service system according to claim 1, characterised in that the main unit is provided with a USB-port (44).

6. Telephone service system according to claim 1, characterised in that the main unit (20) is designed on a plug-in circuit card.

7. Telephone service system according to claim 1, characterised in that the communication between the main unit I/O interface module (28b) for interacting with the main unit (20) and the operator unit I/O interface module (28a) for interacting with the operator unit (22) is wireless.

8. Telephone service system according to claim 1, characterised in that the cellular radio module (26) comprises a protocol converter (170) for conversion of any one of protocol used for MMS or SMS or streaming multimedia and an intermediate image signal, which is transmitted between the protocol converter (170) and the television/cellular radio format converter module (24), which comprises a format converter for conversion between the intermediate image signal and appropriate television or video and audio signals for presentation on the screen/display (16) and in the loudspeakers (18) of the television apparatus (10).

9. A telephone service device for providing telephone services to a television apparatus (10) having television circuitry (14) and a screen/display (16), the device, which consists of two units (20, 22) only, comprises:
a telephone service main unit (20) for connection to the television apparatus (10), and a separate operator unit (22), which is movable in relation to the main unit (20), characterized in that:
the telephone service main unit (20) has a housing, which encloses a television/cellular radio format converter module (24) for interacting with the television circuitry (14) of the television apparatus (10), a cellular radio module (26) for cellular radio communication, operator unit I/O interface module (28a) for interacting with the operator unit (22), and a control processor (30) for controlling the different modules, and signals from the converter module (24) to a cellular network (201) and signals from a cellular network (201) to the converter module (24) will only pass one external interface, the air interface (200); and
the operator unit (22) comprises a main unit I/O interface module (28b) for interacting with the main unit (20), a telephone service indicating means (32), a keyboard (36) and an operator unit controller (60).

10. Telephone service device according to claim 9, characterised in that the separate operator unit (20) comprises a microphone unit (34) for transducing an operator's voice to audio signals.

11. Telephone service device according to claim 9, characterised in that the main unit (20) is provided with a first SCART-interface (40) for connection to a SCART-interface (52) of the television apparatus (10).

12. Telephone service device according to claim 9, characterised in that the main unit is provided with a second SCART-interface for connection to external video equipment.

13. Telephone service device according to claim 9, characterised in that the main unit (20) is provided with a USB-port (44).

14. Telephone service device according to claim 9 characterised in that the main unit (20) is designed on a plug-in circuit card.

15. Telephone service device according to claim 9, characterised in that the main unit (20) and the operator unit (22) is capable of interacting with each other via wireless communication.

16. Telephone service device according to claim 9, characterised in the cellular radio module (26) comprises a protocol converter (170) for conversion of any one of protocol used for MMS or SMS or streaming multimedia and an intermediate image signal, which is transmitted between the protocol converter (26) and the television/cellular radio format converter module (24), which comprises a format converter for conversion between the intermediate image signal and appropriate television or video and audio signals for presentation on the screen/display (16) and in the loudspeakers (18) of the television apparatus (10).

17. Telephone service device according to claim 9, characterised in that the main unit (20) is provided with a USB-port (44).

18. Telephone service device according to claim 11, characterised in that the main unit (20) is provided with a USB-port (44).

19. Telephone service system according to 2, characterised in that the main unit is provided with a USB-port (44).

20. Telephone service system according to claim 3, characterised in that the main unit is provided with a USB-port (44).
